(19) United States
(12) Patent Application Publication
(10) Pub. No.: US 2012/0080638 A1
(43) Pub. Date: Apr. 5, 2012

(54) MAGNETIC RECORDING MEDIUM, MAGNETIC RECORDING-USE MAGNETIC POWDER AND METHOD OF PREPARING THE SAME

(75) Inventor: Yasushi HATTORI, Minami-ashigara-shi (JP)

(73) Assignee: FUJIFILM CORPORATION, Tokyo (JP)

(21) Appl. No.: 13/242,310

(22) Filed: Sep. 23, 2011

(30) Foreign Application Priority Data
Sep. 30, 2010 (JP) 2010-222030
Jan. 24, 2011 (JP) 2011-011563
Sep. 22, 2011 (JP) 2011-206805

(51) Int. Cl. H01F 1/36; C01G 49/02

(52) U.S. Cl. 252/62.63; 423/594.2; 423/594.1

(57) ABSTRACT

An aspect of the present invention relates to a magnetic recording medium comprising a magnetic layer comprising ferromagnetic powder and a binder, wherein the ferromagnetic powder is magnetic powder comprised of gathering magnetic particles, the magnetic particles are a reduction product of hexagonal ferrite magnetic particles wherein a ratio Dc/Dtem of a crystallite size Dc obtained from a diffraction peak of a (220) plane to a particle diameter Dtem in a direction perpendicular to a (220) plane as determined by a transmission electron microscope ranges from 0.90 to 0.75.

### CROSS-REFERENCE TO RELATED APPLICATIONS

This application claims the benefit of priority under 35 USC 119 to Japanese Patent Application No. 2010-222030 filed on Sep. 30, 2010, Japanese Patent Application No. 2011-011563 filed on Jan. 24, 2010, and Japanese Patent Application No. 2011-206805 filed on Sep. 22, 2011, which are expressly incorporated herein by reference in their entirety.

### BACKGROUND OF THE INVENTION

1. Field of the Invention

The present invention relates to magnetic recording-use magnetic powder and to a method of preparing the same. More particularly, the present invention relates to magnetic powder that is suitable for the preparation of a particulate magnetic recording medium having a saturation magnetization that is suited to recording and reproduction systems employing highly sensitive reproduction heads, and to a method of preparing the same.

The present invention further relates to a particulate magnetic recording medium comprising the above magnetic powder.

2. Discussion of the Background

Conventionally, ferromagnetic metal powders have been primarily employed in the magnet layers of high-density recording-use magnetic recording media. These ferromagnetic metal powders are comprised of acicular particles consisting of a main material primarily in the form of iron. Particle size reduction and increased coercive force are sought for high-density recording. These ferromagnetic metal powders are employed in magnetic recording media for various uses.

Since the quantity of information being recorded has been increased in recent years, high-density recording is constantly required of magnetic recording media. However, in achieving ever higher density recording, limits to the improvement in ferromagnetic metal powders have begun to appear. That is because as the particle size of ferromagnetic metal powder decreases, thermal fluctuation ends up causing superparamagnetism, precluding use in magnetic recording media.

By contrast, hexagonal ferrite magnetic powder has high crystal magnetic anisotropy due to its crystalline structure and thus exhibits good thermal stability. Therefore, even with size reduction, it is possible to maintain good magnetic characteristics suited to magnetic recording. Further, magnetic recording media employing hexagonal ferrite magnetic powder in a magnetic layer have high density characteristics due to the vertical component. Thus, hexagonal ferrite magnetic powders are ferromagnetic powders that are suited to high densification.

Various means of further improving hexagonal ferrite magnetic powders having the above advantageous characteristics have been studied in recent years. For example, Document 1 (Japanese Patent No. 2,659,957), which is expressly incorporated herein by reference in its entirety, proposes increasing the saturation magnetization by subjecting substituted hexagonal ferrite magnetic powder to a heat treatment in a reducing atmosphere. Document 2 (Japanese Unexamined Patent Publication (KOKAI) Heisei No. 7-85450) and English language family member U.S. Pat. No. 5,798,176, which are expressly incorporated herein by reference in their entirety, propose increasing the saturation magnetization by subjecting hexagonal plate-like ferrite magnetic powder (hexagonal ferrite magnetic powder) to a reducing treatment.

Both Documents 1 and 2 seek to increase the saturation magnetization of hexagonal ferrite magnetic powders based on the technical thinking that magnetic powder with a high saturation magnetization is desirable. In recording and reproduction systems that employ conventional magnetic induction heads, there is indeed situation that magnetic powder with a high saturation magnetization is desirable. However, in recent years, reproduction heads have advanced to AMR heads and on to GMR heads of increasing sensitivity. In recording and reproduction systems employing these highly sensitive heads, a magnetic recording medium with an excessively high magnetization causes the head to become saturated. Thus, magnetic powders of low saturation magnetization have been demanded for such recording and reproduction systems (for example, see Japanese Patent No. 4,143,713 or English language family member US2003/0168129A1 and U.S. Pat. No. 7,074,281 as well as Japanese Unexamined Patent Publication (KOKAI) No. 2007-246393, which are expressly incorporated herein by reference in their entirety).

### SUMMARY OF THE INVENTION

An aspect of the present invention provides for magnetic recording-use magnetic powder having a saturation magnetization that is suited to recording and reproduction systems employing highly sensitive reproduction heads.

The present inventor conducted extensive research into achieving the above magnetic powder, resulting in the discovery that magnetic particles, obtained as the reduction product of hexagonal ferrite magnetic particles and in which the ratio Dc/Dtem of the crystallite size Dc obtained from the diffraction peak of the (220) plane to the particle diameter Dtem in a direction perpendicular to the (220) plane as determined by a transmission electron microscope fell within a range of 0.90 to 0.75, had a saturation magnetization that was suited to recording and reproduction systems employing highly sensitive reproduction heads. It was also determined that the above magnetic particles could be obtained by subjecting hexagonal ferrite magnetic particles to a reduction treatment in a reducing atmosphere. The above Documents 1 and 2 disclose the reduction of hexagonal ferrite, but in both cases with the object of increasing the saturation magnetization of the hexagonal ferrite. No teaching is given regarding the present invention.

An aspect of the present invention relates to a magnetic recording medium comprising a magnetic layer comprising ferromagnetic powder and a binder, wherein

the ferromagnetic powder is magnetic powder comprised of gathering magnetic particles,

the magnetic particles are a reduction product of hexagonal ferrite magnetic particles wherein a ratio Dc/Dtem of a crystallite size Dc obtained from a diffraction peak of a (220) plane to a particle diameter Dtem in a direction perpendicular to a (220) plane as determined by a transmission electron microscope ranges from 0.90 to 0.75.

A further aspect of the present invention relates to magnetic recording-use magnetic powder comprised of gathering magnetic particles, wherein

the magnetic particles are a reduction product of hexagonal ferrite magnetic particles wherein a ratio Dc/Dtem of a crystallite size Dc obtained from a diffraction peak of a (220) plane to a particle diameter Dtem in a direction perpendicular to a (220) plane as determined by a transmission electron microscope ranges from 0.90 to 0.75.

The hexagonal ferrite magnetic particles may have a composition denoted by general formula AFe₁₂O₁₉ wherein A denotes at least one element selected from the group consisting of Ba, Sr, Pb, and Ca.

The above magnetic powder may have a saturation magnetization of less than 45 A·m²/kg.

The above magnetic powder may have a coercive force of equal to or greater than 120 kA/m but equal to or less than 230 kA/m.

The above magnetic powder may have thermal stability in the form of a gradient of decay of magnetization over time of equal to or less than 0.005 (l/ln(s)).

The above magnetic powder may have thermal stability in the form of a difference of a decay rate A and a decay rate B, B-A, ranging from 0.0001 to 0.0050, wherein the decay rate A is measured by saturating magnetization of the magnetic powder with an external magnetic field of 40,000 Oe at a temperature of 300 K, subsequently changing the external magnetic field to −600 Oe, and measuring the decay rate based on a time at which a demagnetizing field reaches 600 Oe, and the decay rate B is measured by heating the magnetic powder the decay rate A of which has been measured to 320 K at a rate of temperature increase of 5° C./minute, maintaining the magnetic powder for 10 minutes at that temperature, subsequently cooling the magnetic particle to 300 K at a rate of temperature decrease of 5° C./minute, and measuring the decay rate by the same method as that of the decay rate A.

A still further aspect of the present invention relates to a method of preparing magnetic recording-use magnetic powder, which comprises:

subjecting hexagonal ferrite magnetic particles to a heat treatment in a reducing atmosphere to reduce a portion of the hexagonal ferrite magnetic particles, whereby producing magnetic powder comprised of gathering magnetic particles wherein a ratio Dc/Dtem of a crystallite size Dc obtained from a diffraction peak of a (220) plane to a particle diameter Dtem in a direction perpendicular to a (220) plane as determined by a transmission electron microscope ranges from 0.90 to 0.75.

The above method may conduct the heat treatment in a reducing atmosphere at a temperature ranging from 100 to 200° C. for 5 to 30 minutes.

In the above method, the hexagonal ferrite magnetic particles to be heat treated may have a composition denoted by general formula AFe₁₂O₁₉, wherein A denotes at least one element selected from the group consisting of Ba, Sr, Pb, and Ca.

In the above method, the hexagonal ferrite magnetic particles to be heat treated may have a saturation magnetization of equal to or greater than 45 A·m²/kg.

In the above method, the hexagonal ferrite magnetic particles to be heat treated may have a coercive force of equal to or greater than 235 kA/m.

In the above method, the reducing atmosphere may be a hydrogen atmosphere.

The present invention can provides a magnetic recording-use magnetic powder having magnetic characteristics suited to recording and reproduction systems employing highly sensitive reproduction heads.

Other exemplary embodiments and advantages of the present invention may be ascertained by reviewing the present disclosure.

### DETAILED DESCRIPTION OF THE EMBODIMENTS

Unless otherwise stated, a reference to a compound or component includes the compound or component by itself, as well as in combination with other compounds or components, such as mixtures of compounds.

As used herein, the singular forms “a,” “an,” and “the” include the plural reference unless the context clearly dictates otherwise.

Except where otherwise indicated, all numbers expressing quantities of ingredients, reaction conditions, and so forth used in the specification and claims are to be understood as being modified in all instances by the term “about”. Accordingly, unless indicated to the contrary, the numerical parameters set forth in the following specification and attached claims are approximations that may vary depending upon the desired properties sought to be obtained by the present invention. At the very least, and not to be considered as an attempt to limit the application of the doctrine of equivalents to the scope of the claims, each numerical parameter should be construed in light of the number of significant digits and ordinary rounding conventions.

Additionally, the recitation of numerical ranges within this specification is considered to be a disclosure of all numerical values and ranges within that range. For example, if a range is from about 1 to about 50, it is deemed to include, for example, 1, 7, 34, 46.1, 23.7, or any other value or range within the range.

The following preferred specific embodiments are, therefore, to be construed as merely illustrative, and non-limiting to the remainder of the disclosure in any way whatsoever. In this regard, no attempt is made to show structural details of the present invention in more detail than is necessary for fundamental understanding of the present invention; the description making apparent to those skilled in the art how several forms of the present invention may be embodied in practice.

An aspect of the present invention relates to magnetic recording-use magnetic powder comprised of gathering magnetic particles, wherein

the magnetic particles are a reduction product of hexagonal ferrite magnetic particles wherein a ratio Dc/Dtem of a crystallite size Dc obtained from a diffraction peak of a (220) plane to a particle diameter Dtem in a direction perpendicular to a (220) plane as determined by a transmission electron microscope ranges from 0.90 to 0.75.

A further aspect of the present invention relates to a method of preparing magnetic recording-use magnetic powder, which comprises:

subjecting hexagonal ferrite magnetic particles to a heat treatment in a reducing atmosphere to reduce a portion of the hexagonal ferrite magnetic particles, whereby producing magnetic powder comprised of gathering magnetic particles wherein a ratio Dc/Dtem of a crystallite size Dc obtained from a diffraction peak of a (220) plane to a particle diameter Dtem in a direction perpendicular to a (220) plane as determined by a transmission electron microscope ranges from 0.90 to 0.75.

The magnetic powder in the present invention is employed for magnetic recording, and is suitable for use as the ferromagnetic powder contained in the magnetic layer of a particulate magnetic recording medium.

The magnetic particles that constitutes the magnetic powder of the present invention have been obtained by subjecting hexagonal ferrite magnetic particles to a reducing treatment so that the ratio Dc/Dtem of the crystallite size Dc obtained from the diffraction peak of the (220) plane to the particle diameter Dtem in the direction perpendicular to the (220) plane as determined by a transmission electron microscope falls within a range of 0.90 to 0.75.

As a result of research, the present inventor discovered that the ratio of Dc/Dtem could be used as an index of the degree of reduction of hexagonal ferrite magnetic particles, and that the more the reduction progressed, the lower the value of Dc/Dtem became. This was attributed to the following. The reduction of hexagonal ferrite magnetic particles advances from the outer surface toward the interior. The portions that have been reduced go from being crystalline to amorphous. The more reduction progresses, the smaller the crystallite size becomes. However, since the size of the particles themselves essentially does not change, the ratio of the crystallite size and the particle size, Dc/Dtem, decreases as the reduction progresses. The present inventor conducted extensive research resulting in the discovery that when hexagonal ferrite was reduced, in an initial region of reduction progression (referred to as the “first region”, hereinafter), the saturation magnetization and the coercive force gradually decreased relative to their levels prior to the reduction treatment. When the reduction treatment was continued beyond this region, a sharp decrease in the coercive force and a decrease in the saturation magnetization were observed (referred to as the “second region”, hereinafter). When the reduction treatment was continued still further, the coercive force did not undergo a major change but the saturation magnetization increased greatly (referred to as the “third region”, hereinafter). The fact that the magnetic particles corresponding to the first region exhibited a Dc/Dtem ratio falling within a range of 0.90 to 0.75 and the fact that these particles had magnetic characteristics suited to recording and reproduction systems employing highly sensitive reproduction heads were discovered by the present inventor. The present invention was devised on that basis. On the other hand, when the reduction treatment was conducted to the third region, the conversion of Fe contained in the hexagonal ferrite to α-Fe progressed to the point where the presence of α-Fe could be clearly confirmed by X-ray diffraction analysis. In contrast to above Document 1, which discloses a technique relating to the third region, the present invention is an invention relating to the first region, and is thus based on a different technical concept from that of Document 1. When the Dc/Dtem ratio exceeds 0.90, adjustment of saturation magnetization by reduction processing is inadequate and it becomes difficult to achieve a saturation magnetization suited to highly sensitive reproduction heads. Conversely, when the reduction treatment is continued to the point where the Dc/Dtem ratio drops below 0.75, the coercive force drops sharply and thus magnetic particles that are unsuited to magnetic recording form in the second region. When the reduction treatment is continued to the third region, the saturation magnetization begins to increase, which is counter to the object of the present invention. From the perspective of obtaining magnetic characteristics that are suited to recording and reproduction systems employing highly sensitive reproduction heads, the ratio Dc/Dtem of the magnetic particles constituting the magnetic powder of the present invention desirable falls within a range of 0.90 to 0.80.

The magnetic powder of the present invention can be obtained by the method of preparing magnetic powder of the present invention, which includes conducting a heat treatment (reduction treatment) in a reducing atmosphere. The influence of the reduction treatment on the magnetic characteristics of hexagonal ferrite varies greatly with the reduction treatment conditions. Research conducted by the present inventor also revealed the facts that:

(1) under relatively mild reduction treatment conditions (a relatively low heat treatment temperature and short treatment period), the saturation magnetization and coercive force decreased gradually, yielding magnetic particles corresponding to the first region;
(2) when the reduction treatment conditions were intensified relative to the above region, the coercive force dropped sharply, the saturation magnetization dropped, and magnetic particles corresponding to the second region were obtained; and
(3) when the reduction treatment conditions were further intensified, the coercive force did not undergo a major change but the saturation magnetization increased greatly and magnetic particles corresponding to the third region were obtained.

The method of preparing magnetic powder of the present invention can provide magnetic recording-use magnetic powder exhibiting a saturation magnetization suited to recording and reproduction systems employing highly sensitive reproduction heads by subjecting hexagonal ferrite magnetic particles to a reduction treatment under the reduction treatment conditions corresponding to (1) above. It is suitable as a method of preparing the magnetic powder of the present invention.

The present invention will be described in greater detail below.

### Hexagonal Ferrite Magnetic Particles

The hexagonal ferrite magnetic particles that are subjected to a reduction treatment of a degree yielding a ratio Dc/Dtem falling within a range of 0.90 to 0.75 to obtain the magnetic recording medium-use magnetic powder of the present invention can be, for example, barium ferrite, strontium ferrite, lead ferrite, and calcium ferrite; various substitution products thereof such as Co substitution products; and the like. Specific examples are magnetoplumbite-type barium ferrite and strontium ferrite; magnetoplumbite-type ferrite with particle surfaces coated with spinel; and magnetoplumbite-type barium ferrite and strontium ferrite incorporating a partial spinel phase. In addition to the specific atoms, atoms such as Al, Si, S, Sc, Ti, V, Cr, Cu, Y, Mo, Rh, Pd, Ag, Sn, Sb, Te, Ba, Ta, W, Re Au, Hg, Pb, Bi, La, Ce, Pr, Nd, P, Co, Mn, Zn, Ni, Sr, B, Ge and Nb can also be contained. Generally, particles to which elements such as Co—Zn, Co—Ti, Co—Ti—Zr, Co—Ti—Zn, Ni—Ti—Zn, Nb—Zn—Co, Sb—Zn—Co, and Nb—Zn have been added can be employed. Some particles may contain particular impurities based on the starting materials and manufacturing method. It is considered permissible for such particles to be included among the hexagonal ferrite magnetic particles constituting the magnetic powder of the present invention. The desirable ferrite composition of the hexagonal ferrite particles for obtaining the magnetic powder of the present invention will be given further below.

Hexagonal ferrite magnetic particles of high coercive force, generally referred to as hard magnetic powders, are desirably employed as the hexagonal ferrite magnetic particles serving as the starting materials of the magnetic powder of the present invention. This is because magnetic powders of high coercive force have high crystal magnetic anisotropy and good thermal stability, and thus undergo little decrease in magnetic characteristics due to thermal fluctuation even with size reduction for high-density magnetic recording. From this perspective, it is desirable to employ starting material hexagonal ferrite magnetic particles with a coercive force of equal to or greater than 230 kA/m, and preferable to employ those having a coercive force of equal to or greater than 235 kA/m. The coercive force of generally available hexagonal ferrite magnetic particles is normally about equal to or less than 500 kA/m. Since the magnetic powder of the present invention can be obtained without subjecting the hexagonal ferrite magnetic particles to an intense reduction treatment, when starting material magnetic particles with good thermal stability are available, recording properties can be improved without losing the thermal stability of the particles (the saturation magnetization can be adjusted to within a range suited to recording and reproduction systems employing highly sensitive reproduction heads).

The magnetic powder of the present invention normally falls within the above-described first region. Thus, in many cases, the coercive force is somewhat lower than that of the starting material magnetic particles. However, the degree of reduction treatment yields a Dc/Dtem ratio falling within a range of 0.90 to 0.75, so the particles would not exhibit a sharp drop in coercive force. The coercive force of the magnetic powder of the present invention desirably falls within a range of equal to or greater than 120 kA/m but less than 230 kA/m. This is because when the coercive force is excessively low, the influences of adjacent recorded bits make it difficult to maintain recording information and thus thermal stability may deteriorate, and when the coercive force is excessively high, recording is precluded. The coercive force is preferably equal to or greater than 160 kA/m but less than 230 kA/m.

To achieve high thermal stability, the constant of crystal magnetic anisotropy of the starting material hexagonal ferrite magnetic particles is desirably equal to or greater than 0.75×10⁻¹ J/cc (0.75×10⁶ erg/cc), preferably equal to or greater than 1×10⁻¹ J/cc (1×10⁶ erg/cc). The greater the crystal magnetic anisotropy, the smaller the magnetic particles can be, which is advantageous in terms of electromagnetic characteristics such as the SNR. From the perspective of recording characteristics, the constant of crystal magnetic anisotropy of the starting material hexagonal ferrite magnetic particles is desirably equal to or less than 5×10⁻¹ J/cc (0.5×10⁷ erg/cc).

With regard to the hexagonal ferrite, substitute elements replacing Fe can be added as coercive force-adjusting components to lower the coercive force, in the manner described in Document 1. However, the introduction of substitute elements reduces the crystal magnetic anisotropy, and is thus undesirable from the perspective of thermal stability. Accordingly, in the present invention, the use of starting material hexagonal ferrite magnetic particles in the form of hexagonal ferrite magnetic particles not containing substitute elements is desirable. The term “hexagonal ferrite magnetic particles not containing substitute elements” refers to the composition denoted by the general formula AFe₁₂O₁₉ (where A denotes at least one element selected from the group consisting of Ba, Sr, Pb, and Ca). Accordingly, the magnetic particles constituting the magnetic powder of the present invention are desirably in the form of hexagonal ferrite magnetic particles having the composition of the above general formula that have been reduction treated to a degree causing them to exhibit a Dc/Dtem ratio of 0.90 to 0.75.

The use of hexagonal ferrite magnetic particles having the various desirable characteristics set forth above is desirable from the perspective of thermal stability. However, the saturation magnetization of hexagonal ferrite having such characteristics is generally equal to or greater than 45 A·m²/g (45 emu/g) and equal to or less than 1,000 A·m²/g (1,000 emu/g). A saturation magnetization of equal to or greater than 45 A·m²/g (45 emu/g) will cause a drop in sensitivity due to saturation of the highly sensitive heads that have been employed in recent years. By contrast, by reduction treating the hexagonal ferrite magnetic particles to a degree causing them to exhibit a Dc/Dtem ratio of 0.90 to 0.75 in the present invention, the saturation magnetization can be controlled within a range suited to the use of highly sensitive heads. Accordingly, the magnetic powder of the present invention desirably exhibits a saturation magnetization of less than 45 A·m²/g. From the perspective of reproduction output, the saturation magnetization of the magnetic powder of the present invention is desirably equal to or greater than 40 A·m²/g.

The starting material magnetic particles and the magnetic particles constituting the magnetic powder of the present invention can be of any shape, such as spherical or polyhedral. From the perspective of high-density recording, the diameter of the magnetic particles in a direction perpendicular to the (220) plane as determined by a transmission electron microscope (TEM) is desirably 5 to 200 nm, preferably 5 to 25 nm. Specifically, a particle photograph is obtained by imaging the magnetic particles at 100,000-fold magnification with a model H-9000 transmission electron microscope made by Hitachi and printing the image on imaging paper so as to achieve a total magnification of 500,000-fold. The target magnetic particles are selected in the particle photograph, the contours of the powder are traced with a digitizer, and the image analysis software KS-400 from Carl Zeiss is used to measure the major axis diameter in the plate diameter direction of the hexagonal ferrite constituting the particles. Since the plate diameter direction of the hexagonal ferrite coincides with a direction that is perpendicular to the (220) plane, the particle diameter in a direction perpendicular to the (220) plane of the magnetic particle is obtained by this measurement method. The particle diameter in a direction perpendicular to the (220) plane of the magnetic particles is obtained by randomly extracting 500 particles in the photograph taken by a transmission electron microscope, measuring them by the above method, and taking the average value of the particle diameter. The average value of the particle size recorded in the present specification is also obtained by randomly extracting 500 particles from the photograph taken by a transmission electron microscope in this manner and averaging the measured values.

### Reduction Treatment

In the method of preparing magnetic powder of the present invention, hexagonal ferrite magnetic particles are subjected to a heat treatment (reduction treatment) in a reducing atmosphere. A reducing gas in the form of hydrogen, carbon monoxide, hydrocarbon, or the like can be employed. Hydrogen or carbon monoxide is desirable in that it is oxidized during reduction decomposition, and can be removed from the particles as water vapor or carbon dioxide gas, respectively. However, since carbon monoxide is highly toxic, it is desirable to employ hydrogen from the perspectives of safety and ease of handling. From the perspective of the reaction efficiency of the reduction decomposition, the ambient gas during reduction decomposition desirably contains equal to or more than 50 volume percent, preferably equal to or more than 90 volume percent, of the reducing gas. Equipping the reaction vessel with a gas inlet and outlet and discharging the reacted gas while continuously causing reducing gas to flow in during reduction decomposition are particularly desirable from the perspective of reaction efficiency. Reduction decomposition in a flow of reducing gas is advantageous from the perspectives of not introducing Ca as an impurity, such as by Ca reduction, and the fact that by-products of the reduction decomposition are removed in the gas phase. Carbon monoxide or hydrogen diluted with an inert gas can also be desirably employed for safety. Dilution with an inert gas in this manner can also be used to control change in the magnetic characteristics brought about by the reduction treatment.

Equipping the reactor with a gas inlet and outlet and discharging the reacted gas while continuously causing reducing gas to flow in during reduction decomposition are desirable from the perspective of reaction efficiency. The exhaust gas can also be processed with a scrubber to remove by-products of the reduction treatment. The temperature and duration of the heat treatment during the reduction treatment are set to obtain the magnetic powder comprised of gathering reduction treatment products of hexagonal ferrite magnetic particles exhibiting a Dc/Dtem ratio of 0.90 to 0.75. From the perspective of conducting a reduction treatment corresponding to the above-described first region, the heat treatment temperature desirably falls within a range of 100 to 200° C. as the temperature within the reactor. In particular, when employing a reducing gas of high reduction strength (such as pure hydrogen or carbon monoxide), a heat treatment temperature exceeding 200° C. may cause the reduction treatment to progress to the above-described second region, sometimes causing the coercive force to drop sharply. At lower than 100° C., it is sometimes difficult to achieve a Dc/Dtem ratio of equal to or lower than 0.90. The heat treatment temperature is preferably equal to or lower than 195° C. in terms of process management, and preferably equal to or higher than 130° C., and more preferably, equal to or higher than 160° C., from the perspective of shortening the treatment time. The reduction treatment time is not specifically limited and can be set so as to yield magnetic particles with the desired magnetic characteristics based on the concentration of the reducing gas in the reducing atmosphere and the like. A period of about 5 to 30 minutes is desirable from the perspective of productivity and the like, and a period of about 5 to 25 minutes is suitable when employing pure hydrogen, for example.

The reduction treatment can be conducted in a reaction chamber with the hexagonal ferrite magnetic particles in a reaction vessel with an open top. In that case, it is desirable to suitably stir the particles within the vessel so that the hexagonal ferrite magnetic particles positioned at the bottom of the reaction vessel contact the reducing atmosphere. To that end, a rotary kiln or the like is desirably employed. It is also desirable to subject the magnetic particles following the reduction treatment to an oxidation treatment to form an oxide film on the outermost surface thereof to further enhance handling properties. The oxidation treatment can be conducted by a known slow oxidation treatment.

As stated above, the diameter of the hexagonal ferrite magnetic particles constituting the magnetic powder of the present invention is desirably 5 to 200 nm, preferably 5 to 25 nm, in a direction perpendicular to the (220) plane as determined by TEM. Although fine particles are desirable in terms of electromagnetic characteristics such as the SNR, the particles end up exhibiting superparamagnetism when reduced in size, precluding recording. When the particle diameter exceeds 200 nm, magnetic particles exhibiting magnetic characteristics suited to recording and reproduction are present without subjecting them to the above reduction treatment. Accordingly, the magnetic powder of the present invention is desirably comprised of particles with a particle diameter of equal to or less 200 nm that tends not to yield particles suited to recording and reproduction as is.

The present invention can provide magnetic recording-use magnetic powder having desired recording properties without loss of thermal stability when starting material magnetic particles having good thermal stability are employed because hexagonal ferrite magnetic particles are subjected to a relatively mild reduction treatment in the present invention. The details of the thermal stability that is desirable in the magnetic powder of the present invention will be set forth further below in Examples.

The magnetic powder of the present invention as set forth above is employed in magnetic recording and can form a magnetic layer by coating on a support as a coating liquid obtained by mixing it with a binder and a solvent. Accordingly, the magnetic powder of the present invention is suitable for use in particulate magnetic recording media. That is, the present invention further relates to a magnetic recording medium comprising a magnetic layer comprising ferromagnetic powder and a binder, wherein the ferromagnetic powder is the magnetic powder of the present invention. The magnetic recording medium of the present invention can be a magnetic recording medium comprised of a laminate structure sequentially comprising, on a nonmagnetic support, a nonmagnetic layer containing a nonmagnetic powder and a binder and a magnetic layer containing the magnetic powder of the present invention and a binder, and can also be a magnetic recording medium having a backcoat layer on the opposite surface of the nonmagnetic support from the surface on which the magnetic layer is present.

The thickness structure of the magnetic recording medium of the present invention is as follows. The thickness of the nonmagnetic support is, for example, 3 to 80 μm, desirably 3 to 50 μm, and preferably, 3 to 10 μm. The thickness of the nonmagnetic layer is, for example, 0.1 to 3.0 μm, desirably 0.3 to 2.0 μm, and preferably, 0.5 to 1.5 μm. The nonmagnetic layer is effective so long as it is substantially nonmagnetic. For example, it exhibits the effect of the present invention even when it comprises impurities or trace amounts of magnetic material that has been intentionally incorporated, and can be viewed as substantially having the same configuration as the magnetic recording medium of the present invention. The term “substantially nonmagnetic” is used to mean having a residual magnetic flux density in the nonmagnetic layer of equal to or less than 10 mT, or a coercive force of equal to or less than 7.96 kA/m (100 Oe), it being preferable not to have a residual magnetic flux density or coercive force at all.

The thickness of the magnetic layer desirably ranges from 10 to 80 nm, and preferably 30 to 80 nm. It is desirably optimized based on the saturation magnetization level and head gap length of the magnetic head employed and on the recording signal band. The thickness of the backcoat layer is desirably equal to or less than 0.9 μm, and preferably from 0.1 to 0.7 μm.

For details of the magnetic recording medium of the present invention other than those described above, known techniques regarding magnetic recording media can be applied. For example, as for materials and components constituting the magnetic recording medium as well as the manufacturing method of the magnetic recording medium, reference can be made to paragraphs [0030] to [0145] and Examples of Japanese Unexamined Patent Publication (KOKAI) No. 2006-108282, and paragraphs [0024] to [0039], [0068] to [0116] and Examples of Japanese Unexamined Patent Publication (KOKAI) No. 2007-294084. The above applications are expressly incorporated herein by reference in their entirety. In particular, the techniques described in paragraphs [0024] to [0029] of Japanese Unexamined Patent Publication (KOKAI) No. 2007-294084 are desirably applied, in order to obtain a magnetic recording medium with excellent electromagnetic characteristics by highly dispersing the above magnetic powder.

### EXAMPLES

The present invention will be described in detail below based on Examples. However, the present invention is not limited to the examples. The “parts” given in Examples are weight parts.

1. Examples and Comparative Examples of the Magnetic Recording-Use Magnetic Powder

### Examples 1 to 5 and Comparative Examples 1 to 7

The barium ferrite described in Table 1 below (denoted as “BaFe”, hereinafter; ferrite composition: BaFe₁₂O₁₉) was heat treated in a pure hydrogen gas flow in a reactor. During the reduction treatment, the reacted gas was discharged through an outlet while continuously introducing a pure hydrogen gas flow through a gas inlet in the reactor. A Gold Image Reactor (P810C) made by Ulvac-Riko was employed as the reactor. The heating rate was 150° C./min up to the heat treatment temperature indicated in Table 2. Heat treatment was conducted for the period indicated in Table 2 at that temperature. Subsequently, the interior of the reactor was cooled to 40° C. at a cooling rate of 20° C./min, after which air was introduced. Subsequently, the temperature was raised several degrees, after which cooling was conducted to room temperature.

Evaluation Methods

(1) Specific surface area S_{BET}

Measurement of the S_{BET} given in Table 1 was conducted by the nitrogen adsorption method.

(2) Particle size evaluation (average plate diameter, average plate thickness, average particle volume by TEM observation)

The particles sizes given in Table 1 were measured with a transmission electron microscope (applied voltage 200 kV) made by Hitachi.

(3) Magnetic characteristics

The magnetic characteristics of the starting material BaFe (Comparative Example 5) as well as the magnetic powders prepared in Examples 1 to 5 and Comparative Examples 1 to 4, 6, and 7 were evaluated under conditions of an applied magnetic field of 3,184 kA/m (40 kOe) with a superconducting vibrating sample magnetometer (VSM) made by Tamagawa Co.

(4) Measurement of Dc and Dtem

The Dtem was obtained by the method set forth above.

The Dc was obtained by Scherrer's equation from the diffraction peak of the (220) plane as measured by an X-ray diffraction device. In measurement principle, the diffraction peak of the (220) plane is measured as a single peak, so it is possible to obtain the crystallite size from this peak.

The lattice constants of the a axis and c axis were also obtained using Bragg's equation based on the results of the X-ray diffraction analysis that were obtained.

The Dc, Dc/Dtem, and a axis and c axis lattice constants obtained for Examples 1 to 5, Comparative Examples 1 to 4, and the starting material BaFe (Comparative Example 5) by the above method are given in Table 2.

(5) Gradient of decay of magnetization over time

The gradient of decay of magnetization over time due to demagnetizing fields of 400 Oe (about 32 kA/m) and 600 Oe (about 48 kA/m) corresponding to the demagnetizing fields to which a magnetic recording medium is subjected during storage was calculated by the following procedure with a superconducting electromagnet vibrating sample magnetometer (model TM-VSM1450-SM made by Tamagawa Co.) for the starting material BaFe (Comparative Example 5) as well as the magnetic powders prepared in Examples 1 to 5, Comparative Examples 3 and 4. In each measurement, the sample employed was 0.1 g of magnetic powder that was compacted in a measurement holder. The above measurements were not conducted for the magnetic powders prepared in Comparative Examples 1 and 2 because these magnetic powders exhibited excessively low coercive force, as shown in Table 3 below, and thus cannot be compared with the other magnetic powders as equals.

Measurement Method

In the case of thermal fluctuation magnetic aftereffects, ΔM/(Int₁-Int₂) becomes constant in the decay of magnetization over time. Since magnetization also varies depending on the magnetic field, the gradient of the decay of magnetization over time was determined by measuring the magnetization once each increment of time after the magnetic field had been stabilized.

Specifically, an external magnetic field of 40 kOe (about 3,200 kA/m) was applied to the sample. Following direct-current erasure, the magnet was controlled by means of current and current was supplied to generate the target demagnetizing field. The external magnetic field was gradually brought closer to the target demagnetizing field. This was to prevent the decay of magnetization over time from appearing to decrease due to stable processing by varying the external magnetic field.

Designating the time when the magnetic field had reached the target value as the base point in measurement, the magnetization was measured for 25 minutes once every 1 minute and the gradient of the decay of magnetization over time ΔM/(Int₁-Int₂) was obtained. The results are given in Table 3. In Table 3, the value given was obtained by dividing ΔM/(Int₁-Int₂) by the magnetization in a 40 kOe external magnetic field and normalizing the result.

(6) Detection of α-Fe

Surface composition analysis by an X-ray diffraction device of the magnetic particles constituting the magnetic powders prepared in Examples 1 to 5 and Comparative Examples 1 to 4, 6, and 7 as well as the starting material BaFe (Comparative Example 5) revealed no α-Fe peak at 2θ=45° with CuKα rays in the X-ray diffraction spectra of Examples 1 to 5 and Comparative Examples 1 to 5. By contrast, α-Fe peaks were confirmed in the X-ray diffraction spectra of Comparative Examples 6 and 7. In hexagonal ferrite magnetic particles in which the reduction treatment progressed to the degree that α-Fe peaks were confirmed in this manner, a marked drop in coercive force was observed as shown in Table 3 below. Further, since the Dc/Dtem ratio decreased as the reduction treatment progressed as shown in Table 2, the Dc/Dtem ratio was clearly below 0.75.

In X-ray diffraction analysis, a pattern indicating hexagonal ferrite was confirmed in the starting material BaFe (Comparative Example 5) and the magnetic powders of the Examples prepared with reduction treatments and the Comparative Examples. Based on these results, the magnetic particles obtained by the reduction treatment were confirmed to have maintained the crystalline structure of hexagonal ferrite.

TABLE 1

| S_{BET} | Average plate | Average plate | Average particle |
|---|---|---|---|
| (m²/g) | diameter (nm) | thickness (nm) | volume (nm³) |
| 81.7 | 19.5 | 6.7 | 1642 |

TABLE 2

| | Heat treatment | | Crystal- | | Lattice constant | |
|---|---|---|---|---|---|---|
| | in pure hydrogen gas | | lite size | Dc/ | a axis | c axis |
| | Temp. | Period | Dc(nm) | Dtem | (nm) | (nm) |
| Ex. 1 | 150° C. | 25 min | 17.2 | 0.88 | 0.58821 | 2.33067 |
| Ex. 2 | 160° C. | 15 min | 17.4 | 0.89 | 0.58823 | 2.33063 |
| Ex. 3 | 160° C. | 25 min | 17.3 | 0.89 | 0.58827 | 2.33064 |
| Ex. 4 | 200° C. | 15 min | 17.1 | 0.88 | 0.58852 | 2.33480 |
| Ex. 5 | 200° C. | 25 min | 16.7 | 0.86 | 0.58875 | 2.33573 |
| Comp. | 200° C. | 45 min | 14.2 | 0.73 | 0.58978 | 2.34685 |
| Ex. 1 | | | | | | |
| Comp. | 230° C. | 15 min | 13.8 | 0.71 | 0.59033 | 2.35282 |
| Ex. 2 | | | | | | |
| Comp. | 100° C. | 60 min | 18.2 | 0.93 | 0.58814 | 2.32932 |
| Ex. 3 | | | | | | |
| Comp. | 160° C. | 3 min | 18.2 | 0.93 | 0.58813 | 2.32936 |
| Ex. 4 | | | | | | |
| Comp. | — | — | 18.3 | 0.94 | 0.58817 | 2.32934 |
| Ex. 5 | | | | | | |
| (Starting | | | | | | |
| material | | | | | | |
| BaFe) | | | | | | |
| Comp. | 300° C. | 15 min | — | — | — | — |
| Ex. 6 | | | | | | |
| Comp. | 425° C. | 15 min | — | — | — | — |
| Ex. 7 | | | | | | |

TABLE 3

| | | | | Gradient of |
|---|---|---|---|---|
| | | | | decay of |
| | Saturation | | | magnetization |
| | magnetization | coercive | Detection | over time |
| | (A · m²/kg) | force | of α-Fe | (1/ln(s)) |
| Ex. 1 | 44 | 223 kA/m | Not | 0.0028 |
| | | (2800 Oe) | detected | |
| Ex. 2 | 44 | 223 kA/m | Not | 0.0028 |
| | | (2800 Oe) | detected | |
| Ex. 3 | 44 | 223 kA/m | Not | 0.0028 |
| | | (2800 Oe) | detected | |
| Ex. 4 | 44 | 191 kA/m | Not | 0.0040 |
| | | (2400 Oe) | detected | |
| Ex. 5 | 44 | 175 kA/m | Not | 0.0045 |
| | | (2200 Oe) | detected | |
| Comp. | 41 | 72 kA/m | Not | — |
| Ex. 1 | | (900 Oe) | detected | |
| Comp. | 34 | 16 kA/m | Not | — |
| Ex. 2 | | (200 Oe) | detected | |
| Comp. | 45 | 235 kA/m | Not | 0.0024 |
| Ex. 3 | | (2950 Oe) | detected | |
| Comp. | 45 | 235 kA/m | Not | 0.0023 |
| Ex. 4 | | (2950 Oe) | detected | |
| Comp. | 45 | 235 kA/m | Not | 0.0024 |
| Ex. 5 | | (2950 Oe) | detected | |
| (Starting | | | | |
| material | | | | |
| BaFe) | | | | |
| Comp. | 19 | 1.83 kA/m | Detected | — |
| Ex. 6 | | (23 Oe) | | |
| Comp. | 43 | 24.9 kA/m | Detected | — |
| Ex. 7 | | (313 Oe) | | |

As shown in Table 3, the magnetic powders of Comparative Examples 1 and 2 comprised of magnetic particles exhibiting a Dc/Dtem ratio of less than 0.75 exhibited a sharp drop in coercive force relative to the coercive force of the starting material BaFe. Such magnetic powders cannot be readily employed as magnetic recording-use magnetic powders.

Further, in Comparative Examples 3 and 4, with Dc/Dtem ratios exceeding 0.90, due to an inadequate reduction treatment, the magnetic characteristics did not change from those of the starting material BaFe, making it impossible to keep the saturation magnetization within a range suited to recording and reproduction systems employing highly sensitive heads.

By contrast, in the magnetic powders of Examples 1 to 5, which were comprised of magnetic particles obtained by subjecting hexagonal ferrite magnetic particles to a reduction treatment to achieve a Dc/Dtem ratio falling within a range of 0.90 to 0.75, the saturation magnetization was reduced from that of the starting material BaFe and was kept within a range suited to recording and reproduction systems employing highly sensitive heads. There was no sharp drop in coercive force like that of Comparative Examples 1 and 2, and the fact that magnetic powders having coercive forces suited to magnetic recording had been obtained was confirmed. In Examples 1 to 5, the a axis and c axis lattice constants increased somewhat relative to those of the starting material BaFe (Comparative Example 5). That was attributed to the lattice constants increasing due to structural relaxation as a result of the particle surface undergoing reduction decomposition and the barium ferrite particles becoming substantially smaller.

The gradient of decay of magnetization over time as measured by the method set forth above is an index of the thermal stability of a magnetic powder. From the perspective of recording retention properties, magnetic particles in which the gradient of decay of magnetization over time as measured by the method set forth above is equal to or less than 0.0050 (1/ln(s)) are desirable and magnetic particles in which it is equal to or less than 0.0030 (1/ln(s)) are preferred. As shown in Table 3, the gradient of decay of magnetization over time of the magnetic powders of Examples 1 to 5 falls within the above desirable range. This confirms that the reduction treatment in these Examples maintained the high thermal stability of the starting material BaFe without loss. When the thermal stability of the magnetic particle contained in the magnetic layer of the magnetic recording medium is low, it is difficult for energy (magnetic energy) of the magnetic particle for keeping the magnetization orientation to resist thermal energy. As a result, recorded signals decay over time (magnetization decay) and thus reliability of the reproduction signals are deteriorated. Therefore, in order to improve the reliability of the magnetic recording medium, it is required to employ magnetic particles having high thermal stability capable of maintaining recorded signals without significant decay. The lower this gradient is better from the perspective of maintaining recorded signals. Thus, the optimum lower limit is 0.000 (1/ln(s)). However, even above 0.0010 (1/ln(s)), a good practical ability to maintain recorded signals will be present in a normal use environment.

The gradient of decay of magnetization over time is an index of the thermal stability of magnetic powder. This gradient sometimes increases when the temperature is varied. This is thought to occur because raising the temperature reverses the spin of a portion of the interior of the magnetic material, increasing the demagnetizing field by that amount. The fact that the gradient increases when the temperature is varied, that is, the drop in thermal stability, is undesirable. Accordingly, to evaluate the presence of high long-term thermal stability, the magnetic powders of Examples 1 to 5 were evaluated by the following method. The difference (B-A) in the decay rates as measured by the following method desirably falls within a range of 0.0001 to 0.0050, preferably within a range of 0.0001 to 0.0025. Within these ranges, good long-term thermal stability is present and the determination can be made that recorded signals will be well maintained even if a change in temperature occurs during storage.

Measurement Method

Magnetization was saturated with an external magnetic field of 40,000 Oe (about 3,184 kA/m) at a temperature of 300 K. Subsequently, the external magnetic field was changed to −600 Oe (about 48 kA/m). Decay rate A was evaluated based on the time (20 minutes after the external magnetization magnetic field was changed to −600 Oe) at which the demagnetizing field reaches 600 Oe (about 48 kA/m).

Subsequently, the magnetic particle of which the decay rate A had been measured was heated to 320 K at a rate of temperature increase of 5° C./minute and maintained for 10 minutes at that temperature (320 K). The temperature was then decreased to 300 K at a rate of 5° C./minute. Subsequently, in the same manner as above, the magnetization was saturated with an external magnetic field of 40,000 Oe (about 3,184 kA/m), the external magnetic field was changed to Oe (about 48 kA/m), and decay rate B was evaluated based on the time at which the demagnetizing field reaches 600 Oe (about 48 kA/m).

Table 4 gives the results obtained. As shown in Table 4, the difference in the decay rates (B-A) of the magnetic powders obtained in Examples 1 to 5 fell within the above desirable range. Thus, they were determined to have good long-term thermal stability.

TABLE 4

| | Difference in decay rates (B − A) |
|---|---|
| Ex. 1 | 0.0018 |
| Ex. 2 | 0.0019 |
| Ex. 3 | 0.0018 |
| Ex. 4 | 0.0027 |
| Ex. 5 | 0.0030 |

2. Examples and Comparative Example of Magnetic Recording Media

### Examples 6 to 8

### (1) Formulation of Magnetic Layer Coating Liquid

| | | |
|---|---|---|
| Magnetic powder described in Table 5 | 100 | parts |
| Polyurethane resin based on branched side chain- | 15 | parts |
| comprising polyester polyol/diphenylmethane | | |
| diisocyanate, —SO₃Na = 400 eq/ton | | |
| α-Al₂O₃ (particle size: 0.15 μm) | 4 | parts |
| Plate-shaped alumina powder (average particle | 0.5 | part |
| diameter: 50 nm) | | |
| Diamond powder (average particle diameter: 60 nm) | 0.5 | part |
| Carbon black (particle size: 20 nm) | 1 | part |
| Cyclohexanone | 110 | parts |
| Methyl ethyl ketone | 100 | parts |
| Toluene | 100 | parts |
| Butyl stearate | 2 | parts |
| Stearic acid | 1 | part |

### (2) Formulation of Nonmagnetic Layer Coating Liquid

| Nonmagnetic inorganic powder | 85 | parts |
|---|---|---|
| α-iron oxide | | |
| Surface treatment agent: Al₂O₃, SiO₂ | | |
| Major axis diameter: 0.15 μm | | |
| Tap density: 0.8 | | |
| Acicular ratio: 7 | | |
| BET specific surface area: 52 m²/g | | |
| pH: 8 | | |
| DBP oil absorption capacity: 33 g/100 g | | |
| Carbon black | 15 | parts |
| DBP oil absorption capacity: 120 mL/100 g | | |
| pH: 8 | | |
| BET specific surface area: 250 m²/g | | |
| Volatile content: 1.5 percent | | |
| Polyurethane resin based on branched side chain- | 22 | parts |
| comprising polyester polyol/diphenylmethane | | |
| diisocyanate, —SO₃Na = 200 eq/ton | | |
| Phenylphosphonic acid | 3 | parts |
| Cyclohexanone | 140 | parts |
| Methyl ethyl ketone | 170 | parts |
| Butyl stearate | 2 | part |
| Stearic acid | 1 | part |

### (3) Formulation of Backcoat Layer Coating Liquid

| | | |
|---|---|---|
| Carbon black (average particle diameter: 25 nm) | 40.5 | parts |
| Carbon black (average particle diameter: 370 nm) | 0.5 | part |
| Barium sulfate | 4.05 | parts |
| Nitrocellulose | 28 | parts |
| SO₃Na group-containing polyurethane resin | 20 | parts |
| Cyclohexanone | 100 | parts |
| Toluene | 100 | parts |
| Methyl ethyl ketone | 100 | parts |

### (4) Preparation of Coating Liquid for Forming Each Layer

The components of each of the above-described magnetic layer coating liquid, nonmagnetic layer coating liquid, and backcoat layer coating liquid were kneaded for 240 minutes in an open kneader and dispersed using a bead mill (1,440 minutes for the magnetic layer coating liquid, 720 minutes for the nonmagnetic layer coating liquid, and 720 hours for the backcoat layer coating liquid). To each of the dispersions obtained were added four parts of trifunctional low-molecular-weight polyisocyanate compound (Coronate 3041 made by Nippon Polyurethane Industry Co.), and the mixtures were stirred for another 20 minutes. Subsequently, the mixtures were filtered using a filter having an average pore diameter of 0.5 μm. The magnetic layer coating liquid was then centrifugally separated for 30 minutes at a rotational speed of 10,000 rpnm in a cooled centrifugal separator, the Himac CR-21D, made by Hitachi High Tech, to conduct grading to remove the aggregate.

### (5) Preparation of Magnetic Tape

The nonmagnetic layer coating liquid obtained was coated to a PEN support with a thickness of 5 μm (an average surface roughness Ra=1.5 nm as measured with an HD2000 made by WYKO) in a quantity calculated to yield a dry thickness of 1.5 μm, and dried at 100° C. The support stock material on which the nonmagnetic layer had been coated was then subjected to a 24-hour heat treatment at 70° C. The magnetic layer coating liquid that had been graded was wet-on-dry coated on the nonmagnetic layer in a quantity calculated to yield the thickness of 20 nm upon drying and dried at 100° C. On the surface of the support opposite to the surface on which the magnetic layer has been provided, the backcoat layer coating liquid was coated and dried to yield a backcoat layer with a thickness of 0.5 μm.

A seven-stage calender comprised only of metal rolls was then used to conduct processing to smoothen the surface at a temperature of 100° C. and a linear pressure of 350 kg/cm at a speed of 100 m/min. The material was then slit into a ½ inch width to obtain magnetic tape.

### Comparative Example 8

With the exception that the starting material BaFe employed in 1. above (i.e., Examples and Comparative Examples of magnetic powders) was employed as the magnetic powder, a magnetic tape was prepared in the same manner as in Examples 6 to 8.

### (6) Evaluation of Magnetic Tapes

### (6-1) Coercive Force

It was evaluated under conditions of an applied magnetic field of 3,184 kA/m (40 kOe) with a superconducting vibrating sample magnetometer (VSM) made by Tamagawa Co.

### (6-2) Electromagnetic Characteristics (ORC, SNR)

Measurement of electromagnetic characteristics was conducted with a drum tester (relative speed 5 m/s).

1) ORC

A write head with a gap length of 0.2 μm and Bs=1.6 T was used to record a signal at a linear recording density of 275 kfci. The signal was reproduced with a GMR head (Tw width 3 μm, sh-sh=0.18 μm). The recording current was changed and current at which output was maximum was applied as an optimal recording current (ORC).

2) SNR

Under the condition described in 1) above, signals were recorded and reproduced at the optimal recording current obtained in 1) above. The ratio of the 275 kfci output to 0 to 2×275 kfci integral noise was measured.

Results are given in Table 5. The SNR shown in Table 5 is a relative value based on the measured value of Comparative Example 8.

TABLE 5

| | Magnetic | Coercive force | ORC | SNR |
|---|---|---|---|---|
| | powder | of medium | (mA) | (dB) |
| Ex. 6 | Ex. 3 | 247 kA/m | 14.3 | 0.9 |
| | | (3100 Oe) | | |
| Ex. 7 | Ex. 4 | 196 kA/m | 11.5 | 1.4 |
| | | (2460 Oe) | | |
| Ex. 8 | Ex. 5 | 175 kA/m | 10.0 | 1.6 |
| | | (2200 Oe) | | |
| Comp. | Starting | 267 kA/m | 15.5 | 0 |
| Ex. 8 | material BaFe | (3360 Oe) | | |

As shown in Tables 3 and 4 above, magnetic powders of Examples 3 to 5 had high thermal stability. As shown in Table 5, magnetic tapes prepared with these magnetic powders exhibited higher SNR with lower recording current than the magnetic tape of Comparative Example 8 prepared with the starting material BaFe.

From the above results, it was revealed that the present invention could provide magnetic powders having both high thermal stability and excellent recording properties and that, with the use of such magnetic powders, magnetic recording media having both high reliability and excellent recording properties can be provided.

The magnetic powder of the present invention is suitable for use in particulate magnetic recording media.

Although the present invention has been described in considerable detail with regard to certain versions thereof, other versions are possible, and alterations, permutations and equivalents of the version shown will become apparent to those skilled in the art upon a reading of the specification and study of the drawings. Also, the various features of the versions herein can be combined in various ways to provide additional versions of the present invention. Furthermore, certain terminology has been used for the purposes of descriptive clarity, and not to limit the present invention. Therefore, any appended claims should not be limited to the description of the preferred versions contained herein and should include all such alterations, permutations, and equivalents as fall within the true spirit and scope of the present invention.

Having now fully described this invention, it will be understood to those of ordinary skill in the art that the methods of the present invention can be carried out with a wide and equivalent range of conditions, formulations, and other parameters without departing from the scope of the invention or any Examples thereof.

All patents and publications cited herein are hereby fully incorporated by reference in their entirety. The citation of any publication is for its disclosure prior to the filing date and should not be construed as an admission that such publication is prior art or that the present invention is not entitled to antedate such publication by virtue of prior invention.

What is claimed is:

1. A magnetic recording medium comprising a magnetic layer comprising ferromagnetic powder and a binder, wherein
the ferromagnetic powder is magnetic powder comprised of gathering magnetic particles,
the magnetic particles are a reduction product of hexagonal ferrite magnetic particles wherein a ratio Dc/Dtem of a crystallite size Dc obtained from a diffraction peak of a (220) plane to a particle diameter Dtem in a direction perpendicular to a (220) plane as determined by a transmission electron microscope ranges from 0.90 to 0.75.

2. The magnetic recording medium according to claim 1, wherein the hexagonal ferrite magnetic particles have a composition denoted by general formula AFe₁₂O₁₉ wherein A denotes at least one element selected from the group consisting of Ba, Sr, Pb, and Ca.

3. The magnetic recording medium according to claim 1, wherein the magnetic powder has a saturation magnetization of less than 45 A·m²/kg.

4. The magnetic recording medium according to claim 1, wherein the magnetic powder has a coercive force of equal to or greater than 120 kA/m but equal to or less than 230 kA/m.

5. The magnetic recording medium according to claim 1, wherein the magnetic powder has thermal stability in the form of a gradient of decay of magnetization over time of equal to or less than 0.005 (l/ln(s)).

6. The magnetic recording medium according to claim 1, wherein the magnetic powder has thermal stability in the form of a difference of a decay rate A and a decay rate B, B-A, ranging from 0.0001 to 0.0050, wherein the decay rate A is measured by saturating magnetization of the magnetic powder with an external magnetic field of 40,000 Oe at a temperature of 300 K, subsequently changing the external magnetic field to −600 Oe, and measuring the decay rate based on a time at which a demagnetizing field reaches 600 Oe, and the decay rate B is measured by heating the magnetic powder the decay rate A of which has been measured to 320 K at a rate of temperature increase of 5° C./minute, maintaining the magnetic powder for 10 minutes at that temperature, subsequently cooling the magnetic particle to 300 K at a rate of temperature decrease of 5° C./minute, and measuring the decay rate by the same method as that of the decay rate A.

7. Magnetic recording-use magnetic powder comprised of gathering magnetic particles, wherein
the magnetic particles are a reduction product of hexagonal ferrite magnetic particles wherein a ratio Dc/Dtem of a crystallite size Dc obtained from a diffraction peak of a (220) plane to a particle diameter Dtem in a direction perpendicular to a (220) plane as determined by a transmission electron microscope ranges from 0.90 to 0.75.

8. The magnetic recording-use magnetic powder according to claim 7, wherein the hexagonal ferrite magnetic particles have a composition denoted by general formula AFe₁₂O₁₉ wherein A denotes at least one element selected from the group consisting of Ba, Sr, Pb, and Ca.

9. The magnetic recording-use magnetic powder according to claim 7, which has a saturation magnetization of less than 45 A·m²/kg.

10. The magnetic recording-use magnetic powder according to claim 7, which has a coercive force of equal to or greater than 120 kA/m but equal to or less than 230 kA/m.

11. The magnetic recording-use magnetic powder according to claim 7, which has thermal stability in the form of a gradient of decay of magnetization over time of equal to or less than 0.005 (l/ln(s)).

12. The magnetic recording-use magnetic powder according to claim 7, which has thermal stability in the form of a difference of a decay rate A and a decay rate B, B-A, ranging from 0.0001 to 0.0050, wherein the decay rate A is measured by saturating magnetization of the magnetic powder with an external magnetic field of 40,000 Oe at a temperature of 300 K, subsequently changing the external magnetic field to −600 Oe, and measuring the decay rate based on a time at which a demagnetizing field reaches 600 Oe, and the decay rate B is measured by heating the magnetic powder the decay rate A of which has been measured to 320 K at a rate of temperature increase of 5° C./minute, maintaining the magnetic powder for 10 minutes at that temperature, subsequently cooling the magnetic particle to 300 K at a rate of temperature decrease of 5° C./minute, and measuring the decay rate by the same method as that of the decay rate A.

13. A method of preparing magnetic recording-use magnetic powder, which comprises:
subjecting hexagonal ferrite magnetic particles to a heat treatment in a reducing atmosphere to reduce a portion of the hexagonal ferrite magnetic particles, whereby producing magnetic powder comprised of gathering magnetic particles wherein a ratio Dc/Dtem of a crystallite size Dc obtained from a diffraction peak of a (220) plane to a particle diameter Dtem in a direction perpendicular to a (220) plane as determined by a transmission electron microscope ranges from 0.90 to 0.75.

14. The method of preparing according to claim 13, which conducts the heat treatment in a reducing atmosphere at a temperature ranging from 100 to 200° C. for 5 to 30 minutes.

15. The method of preparing according to claim 13, wherein the hexagonal ferrite magnetic particles to be heat treated have a composition denoted by general formula AFe₁₂O₁₉, wherein A denotes at least one element selected from the group consisting of Ba, Sr, Pb, and Ca.

16. The method of preparing according to claim 13, wherein the hexagonal ferrite magnetic particles to be heat treated have a saturation magnetization of equal to or greater than 45 A·m²/kg.

17. The method of preparing according to claim 13, wherein the hexagonal ferrite magnetic particles to be heat treated have a coercive force of equal to or greater than 235 kA/m.

18. The method of preparing according to claim 13, wherein the reducing atmosphere is a hydrogen atmosphere.
